(19) United States
(12) Patent Application Publication
(10) Pub. No.: US 2026/0039541 A1
(43) Pub. Date: Feb. 5, 2026

(54) OUTAGE PREDICTION IN WIRELESS COMMUNICATION NETWORKS

(71) Applicant: T-Mobile USA, Inc., Bellevue, WA (US)

(72) Inventors: Henry P. Cyril, Bothell, WA (US); Shrustishree Sumanth, Bellevue, WA (US)

(21) Appl. No.: 18/789,455

(22) Filed: Jul. 30, 2024

(51) Int. Cl. H04L 41/0677; H04L 41/0631; H04L 41/16

(52) U.S. Cl. CPC H04L 41/0677; H04L 41/0631; H04L 41/16

(57) ABSTRACT

Systems, methods, and devices that relate to an AI-based engine that identifies patterns indicative of potential service disruptions. The AI-based engine interfaces with the network provisioning engine to gather real-time transaction data encompassing user requests, network nodes, and service attributes. Using one or more AI models trained on historical transaction data, the AI-based engine identifies patterns indicative of potential service disruptions. Upon detecting anomalies in the current transaction data, the AI-based engine can signal potential disruptions by generating one or more alerts for one or more network provisioning engines. The AI-based engine can generate recommendations for corrective actions or automatically implement the corrective actions.

### BACKGROUND

In telecommunication, provisioning involves the process of preparing and equipping a network to allow the network to provide new services to the network's users. During network provisioning, services which are assigned to the customer in the customer relationship management (CRM) are provisioned on the network element which is enabling the service and allows the customer to use the service. During the provisioning, a network provisioning engine (NPE) translates the service and the corresponding parameters of the service to one or more services/parameters on the network elements involved. The algorithm used to translate a system service into network services is called provisioning logic.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example architecture of a Network Provisioning Engine (NPE) in accordance with one or more implementations of the present technology.

FIG. 4 illustrates an example architecture of an AI-based engine to predict network element issues in accordance with one or more implementations of the present technology.

FIG. 5 is a flowchart representation of a process or a method for predicting network element issues in wireless networks in accordance with one or more implementations of the present technology.

FIG. 6 is a high-level block diagram illustrating an example AI system, in accordance with one or more implementations.

FIG. 7 is a block diagram that illustrates an example of a computer system in which at least some operations described herein can be implemented.

The technologies described herein will become more apparent to those skilled in the art from studying the Detailed Description in conjunction with the drawings. Implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A wireless communication network operator offers diverse rate plans to subscribers, each featuring distinct customer segments and service attributes. For instance, prepaid plans require upfront payment and balance maintenance for services like calls, while postpaid plans bill users monthly based on usage. Features such as tethering, 5G access, data limits, unlimited calling, and call forwarding vary across these plans. Network provisioning systems manage plan features through customer-facing specifications (CFS), converting them to network-facing specifications (NFS) using network provisioning engines (NPEs) and catalogs. Wireless communication networks are composed of numerous network nodes/elements, each responsible for different aspects of service delivery, such as short message service (SMS), multi-media messaging service (MMS), and rich communication services (RCS) messaging. When a user experiences a service issue, the issue often stems from a misconfiguration or failure in one or more of the network nodes/elements. The conventional approach to resolving such issues involves manual intervention by customer service representatives and technicians, which is not only time-consuming but also prone to errors. This manual process can lead to prolonged service outages and significant user dissatisfaction.

The disclosed techniques use an artificial intelligence (AI)-based engine to preemptively detect and resolve network issues. The AI-based engine uses AI models to analyze real-time and historical data from provisioning logs to identify anomalies and predict disruptions. When anomalies arise, the AI-based engine can identify the cause of the anomaly. In some implementations, the AI-based engine uses forecasting models to predict future network conditions. By analyzing historical data and detected anomalies, the forecasting module can anticipate network load increases, potential capacity issues, and other factors that can lead to service degradation. Further, the AI-based engine can recommend or implement corrective actions (e.g., reconfiguring network elements) automatically to resolve the anomaly. For example, if an anomaly is detected that indicates increased traffic on specific network elements, the AI-based engine can suggest and/or automatically implement reallocating bandwidth or processing power to prevent congestion.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

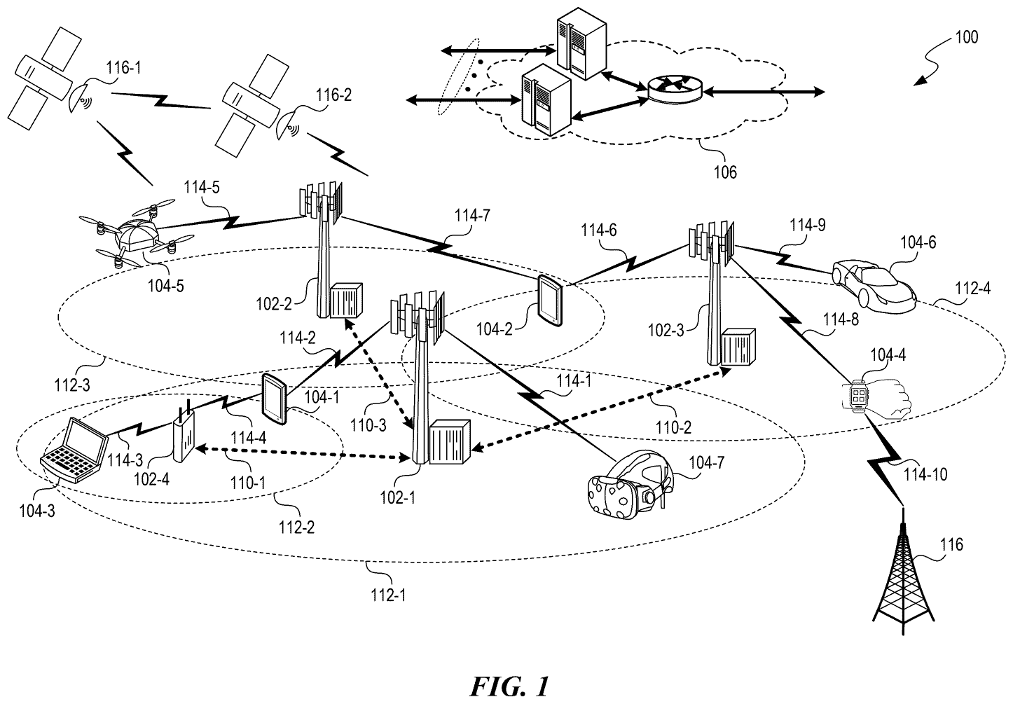

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 702.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

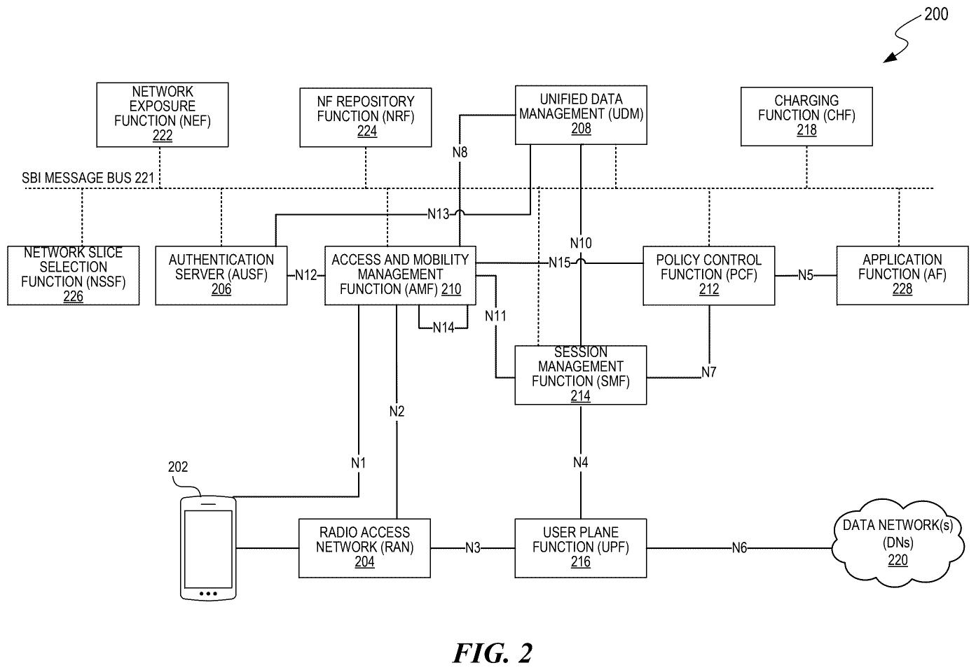

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Predicting Outages in Network Elements of a Wireless Communication Network

A wireless communication network operator offers different rate plans to their subscribers. The customer segment and the features or services offered by the rate plan can differ substantially between different plans. For example, prepaid plans require customers to prepay and have a balance before using a service like making a call, whereas postpaid plans allow users to accumulate charges and bill the customer at the end of each month. Features such as tethering service, 5G access, the number of gigabytes of online data, unlimited calling, and call forwarding vary between the different rate plans.

The network provisioning requirements for the features or services provided by the rate plans differ correspondingly. In some wireless communication networks, introducing new features or modifying existing features for the different rate plans can occur via a network provisioning system that includes one or more network provisioning engines (NPEs). Each rate plan can be translated into a set of features defined by customer-facing specifications (CFS). The NPE receives the CFSs from the billing system and converts each CFS to a network-facing specification (NFS) (e.g., network service attributes), e.g., a user network profile, based on a look-up in the network provisioning catalog. In particular, the network provisioning catalog can provide network elements of the wireless communication network related to the CFS, e.g., network elements that implement various aspects of the CFS to provide services to users in accordance with the rate plans.

However, if there is an issue that arises with respect to any network element of a corresponding user network profile, the issue can lead to a corresponding user's full services not working, or partial service degradation. Because there are numerous network elements that provide services in the wireless communication network, the user can experience service issues when the user's profile at a network element does not match the appropriate user profile. For example, for texting services, a first network element handles SMS messages, a second network element handles MMS messages, while a third set of servers handles RCS. If a user of the wireless communication network has problems with any of the services, the user can contact an operator of the wireless communication network and indicate that there is a problem with MMS. A customer service representative can then try to fix the problem manually based on suggestions in a customer service manual. If the customer service representative is unable to fix the problem, then the customer service representative can open a ticket and a technician can then try to fix the problem. The technician can perform provisioning behind the scenes in order to fix the problem and can investigate the various network elements (including the user's profile at each network element) involved in providing MMS to the user. This is a very time-consuming process. One option for fixing the problem can be to fully reactivate the service. For example, the technician can deactivate the service and then reactivate the service for the user. However, this can result in deletion of the user's data, including for example, previous messages, profiles, contact info, etc.

This patent document discloses techniques that can be implemented in various implementations to proactively predict and resolve network element issues before the issues impact the end user's service experience. An AI-based engine communicates with the NPE to monitor network performance and user profile data across various network elements to identify potential anomalies and predict service disruptions. By using one or more AI models, the AI-based engine can detect patterns and trends that indicate potential failures or degradations in the network elements. The AI-based engine analyzes real-time provisioning transactions, historical performance data, and metadata from the NPE. The AI-based engine can ingest data from various logs and metrics, such as provisioning logs, response times, and error rates from the NPE. One or more AI models within the AI-based engine are trained to recognize the normal operating conditions of the network and identify deviations that suggest underlying issues (e.g., detecting anomalies). In some implementations, the AI-based engine can include a forecasting module that analyzes the detected anomalies in conjunction with historical data to predict future trends and potential risks. By applying time series forecasting models such as ARIMA (Autoregressive Integrated Moving Average) and/or Prophet, the AI-based engine can anticipate network load increases, potential capacity issues, and other factors that can lead to service degradation. The forward-looking approach allows the network operations team to take preemptive actions, such as scaling up resources or adjusting network configurations, to mitigate the anticipated issues.

In some implementations, when an anomaly is detected, the AI-based engine not only identifies the cause of the anomaly but also recommends and/or initiates corrective actions automatically. The proactive approach ensures that potential problems are addressed before they escalate to significant outages, thereby maintaining service continuity and enhancing overall network reliability. By automating the detection and resolution of network issues, the AI-based engine lowers the need for user-initiated support calls and lengthy manual investigations. This not only improves operational efficiency but also enhances customer satisfaction by providing uninterrupted service and reducing the frustration associated with network issues.

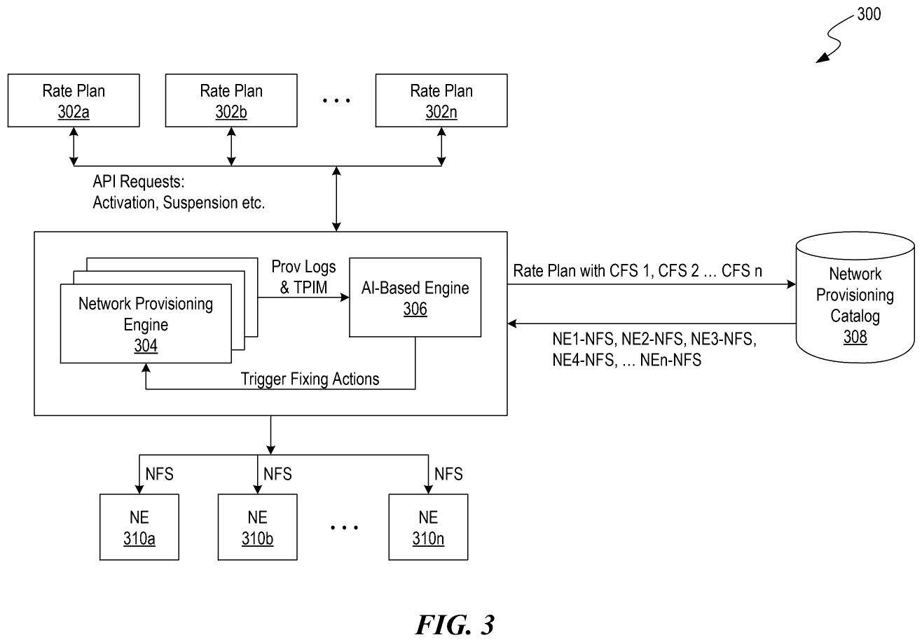

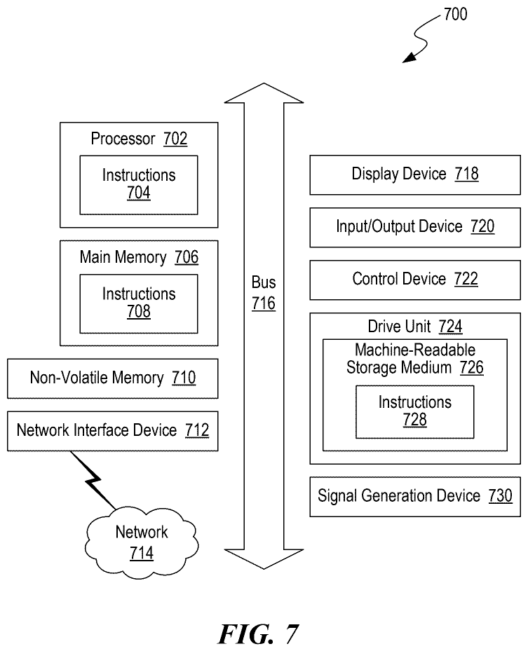

FIG. 3 illustrates an example architecture 300 associated with a Network Provisioning Engine (NPE) in accordance with one or more implementations of the present technology. The example architecture 300 can be implemented using components of the example computer system 700 illustrated and described in more detail with reference to FIG. 7. Likewise, implementations of architecture 300 can include different and/or additional components or can be connected in different ways.

In FIG. 3, rate plans 302a-n refer to the various subscription packages or service plans offered to users within the wireless communication network. Each rate plan 302a-n can define specific user service attributes, which are the requirements and preferences of the users based on the user's chosen subscription package. The user service attributes can include features such as data limits, voice call allowances, messaging capabilities, and/or pricing structures. For example, a basic rate plan can offer limited data usage and a fixed number of voice call minutes, while a premium plan can provide unlimited data, high-speed 5G access, and additional features such as tethering and international calling. Rate plans 302a-n can cater to different user needs and preferences, providing a range of options for customers to choose from based on the user's usage patterns and budget.

When a user requests a service, NPEs 304 receive the request and uses the specified user service attributes (e.g., CFSs) to initiate the provisioning process. The NPEs 304 acts as an intermediary between the user's service request and the corresponding network elements configured to fulfill the particular service request. The NPEs 304 can consult the network provisioning catalog 308 to retrieve information about the corresponding network elements 310a-n and the corresponding network elements' 310a-n associated service attributes (e.g., NFSs). The information includes the capabilities and configurations required to fulfill the user's service request, such as the specific bandwidth allocations, quality of service (QoS) parameters, and/or routing protocols used to deliver the requested services. In some implementations, by accessing the network provisioning catalog 308, the NPEs 304 can translate the CFSs into NFSs, which are then used to configure the network elements accordingly.

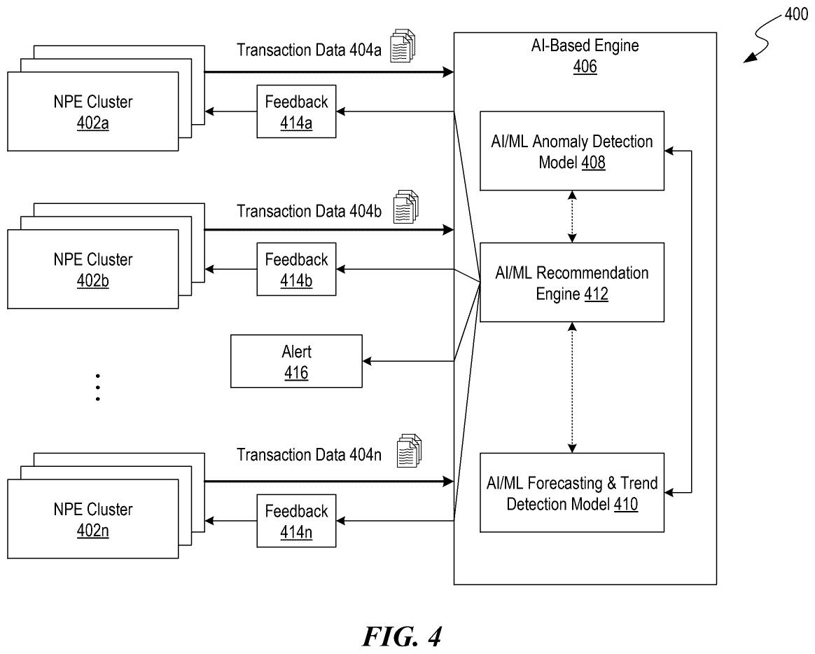

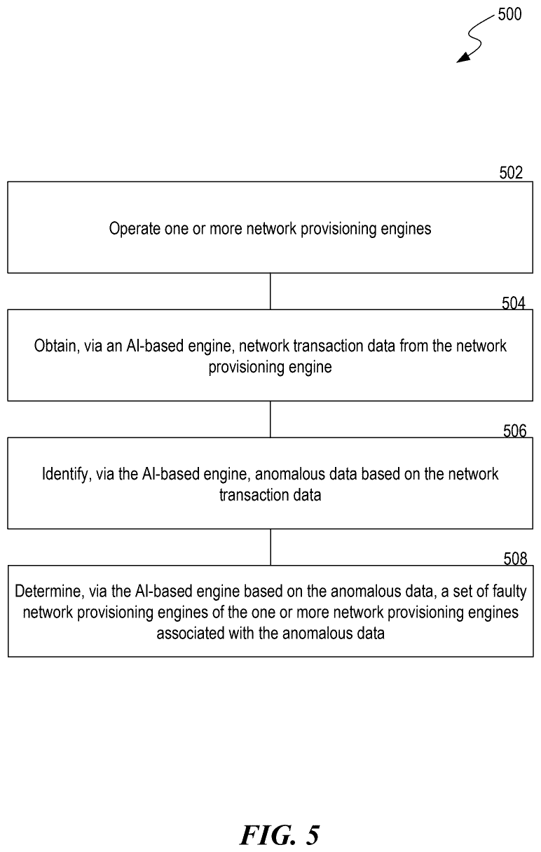

The AI-based engine 306 continuously monitors the network performance by analyzing data from the NPEs 304 and the network elements 310a-n. The monitored data can include real-time provisioning transactions, historical performance metrics, user profile data, and metadata from various network elements. The AI-based engine 306 can use various AI models, including forecasting, trend detection, and anomaly detection models, to predict potential network issues, identify emerging trends, and detect anomalies in real-time data. Methods of using the various AI models are discussed with further reference to FIG. 4 and FIG. 5. The AI-based engine 306 improves the network's reliability and performance by proactively addressing potential disruptions in service. For example, the trend detection model can identify normal operating conditions and any deviations from the normal operating conditions, helping the network understand long-term behaviors. The anomaly detection model can detect any unusual patterns or outliers, enabling the system to identify and address potential issues before the anomalies impact the user experience. Additionally, the forecasting model can predict future network conditions, allowing the AI-based engine 306 to determine if the current network conditions align with expected network conditions.

FIG. 4 illustrates an example architecture 400 of an AI-based engine to predict network element issues in accordance with one or more implementations of the present technology. The AI-based engine 406 in this example can be the same as or similar to AI-based engine 306 in FIG. 3. The example architecture 400 can be implemented using components of the example computer system 700 illustrated and described in more detail with reference to FIG. 7. Likewise, implementations of architecture 400 can include different and/or additional components or can be connected in different ways.

In FIG. 4, NPE clusters 402a-n refer to groups of NPEs (e.g., NPEs 304) that operate together to manage and provision network services across different segments of the network. Each cluster can include multiple NPEs working in tandem to handle large volumes of service requests and distribute the workload. NPE clusters 402a-n can generate transaction data 404a-n, which includes records of network interactions and operations. For example, transaction data can include information such as service requests, network element configurations, user profiles, provisioning logs, response times, error rates, and/or other relevant metrics. The transaction data can be related to the network's operational state.

Service requests can include various types of user-initiated actions, such as requests for data transmission, voice calls, and/or multimedia streaming services. Network element configurations can refer to the specific settings and parameters of the hardware and software components within the network, such as routers, switches, and servers, which dictate how these elements operate and interact with each other. User profiles can contain information about individual users, including the users' service plans, usage patterns, and/or preferences. Provisioning logs are records of the processes involved in setting up and managing network services, such as the allocation of resources and the activation or deactivation of services. Response times measure the latency between a service request and the corresponding response from the network, which can indicate the efficiency and speed of the network's operations. Error rates track the frequency of errors or failures occurring within the network, such as dropped calls, failed data transmissions, or configuration errors.

Other relevant metrics can include metrics such as bandwidth utilization, packet loss rates, jitter, and/or throughput, which provide an indication of the network's performance and health. For example, bandwidth utilization measures the amount of data being transmitted over the network relative to the network's capacity, and packet loss rates indicate the percentage of data packets that fail to reach their destination. Jitter measures the variability in packet arrival times, which can affect the quality of real-time communications like VoIP or video conferencing. Throughput quantifies the actual data transfer rate achieved over the network, which can reflect the network's ability to handle traffic loads.

Each NPE within a NPE cluster 402a-n can be responsible for specific task(s), such as validating service requests, retrieving configuration data from the network provisioning catalog, and/or executing the necessary provisioning actions on the relevant network elements. In some implementations, the NPE clusters 402a-n can scale horizontally to allow the network to add more NPEs as needed to accommodate increasing service demands.

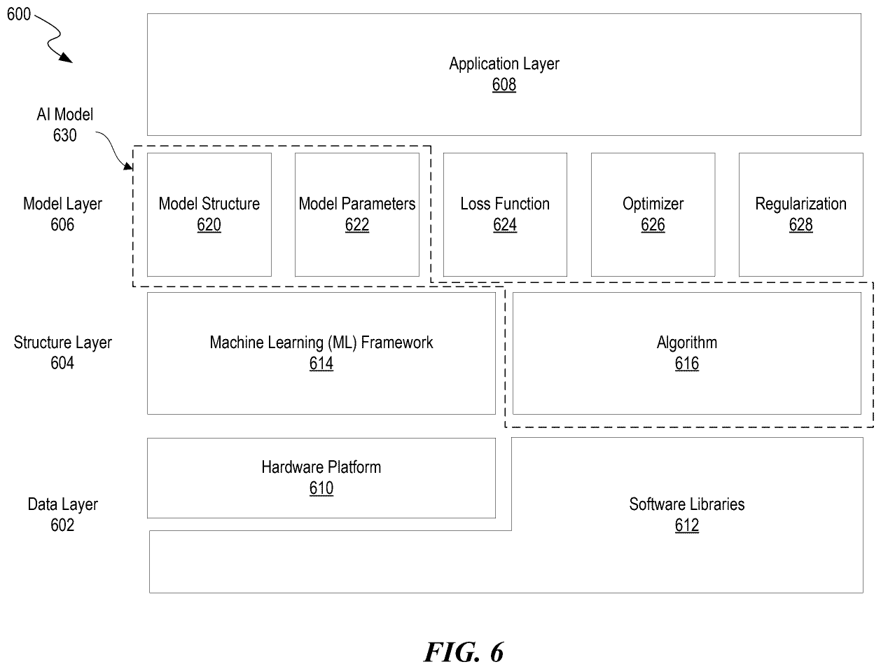

The AI-based engine 406, which integrates multiple AI models, continuously analyzes transaction data 404a-n (e.g., real-time provisioning transactions, historical performance metrics, metadata from network elements, and other relevant data points) to proactively detect anomalies in network performance. The training process of one or more AI models can include using machine learning techniques described in further detail with reference to FIG. 6 to create a baseline of normal network behavior, against which deviations are measured.

In some implementations, the transaction data 404a-n is fed into an anomaly detection model 408, which can be trained on historical transaction data to recognize patterns and trends that precede network issues. The anomaly detection model 408 can identify outliers that fall outside the normal range of operation, indicating potential issues. The anomaly detection model 408 can use, for example, Gaussian distribution modeling, where anomalies are detected based on deviations from expected statistical distributions of network parameters. Techniques like ARIMA or Seasonal Decomposition of Time Series (STL) can additionally or alternatively be used to analyze temporal patterns and trends to identify anomalies over time. For example, ARIMA can be used to forecast future values based on past observations, and/or STL can be used to decompose time series data into trend, seasonal, and residual components, making it easier to spot irregularities.

Further, clustering algorithms such as k-means or Density-Based Spatial Clustering of Applications with Noise (DBSCAN) can additionally or alternatively be used to group similar network behavior patterns and flag outliers as potential anomalies. Clustering techniques enable the AI-based engine to detect, for example, sudden spikes in traffic and/or gradual performance degradation. K-means clustering partitions the data into distinct groups based on similarity. The anomaly detection model can initialize a set number of centroids, which represent the center of each cluster. Data points can be assigned to the nearest centroid, and the centroids are recalculated based on the mean of the assigned points. The anomaly detection model 408 can iterate the process until the centroids stabilize and group similar data points together. For example, in a network environment, k-means can cluster data points related to metrics such as average packet transmission rates, typical bandwidth usage, and/or standard latency times under normal operating conditions. By establishing these clusters, the anomaly detection model 408 can identify when a data point deviates significantly from the norm. For instance, if the average packet transmission rate for a particular network segment suddenly increases by an order of magnitude, the spike can be flagged as an anomaly. Similarly, if bandwidth usage for a specific service, such as video streaming, suddenly triples during off-peak hours, the unusual usage pattern can be detected as an outlier.

On the other hand, DBSCAN identifies dense regions of data points and marks data points that do not fit into any cluster as anomalies. Unlike k-means, DBSCAN does not require the number of clusters to be specified beforehand. Instead, DBSCAN uses two parameters: epsilon (¿), which defines the radius of a neighborhood around a data point, and the minimum number of points required to form a dense region. Data points within E distance of each other are considered part of the same cluster if they meet the minimum points criterion. Points that do not meet this criterion are labeled as noise or outliers. For example, in a network setting, DBSCAN can identify a sudden increase in packet loss rates in a specific portion of the network, which can indicate a localized hardware failure or a configuration issue.

Once an anomaly is detected, the AI-based engine 406 can evaluate the anomaly to pinpoint the source of the issue. The AI-based engine 406 can correlate anomalous data with known network configurations, user profiles, and service dependencies to determine the underlying cause. For example, if a spike in response times is detected for a particular API that handles SMS messages, the AI-based engine 406 will examine the relevant network elements (e.g., NEs 310a-n in FIG. 3), their configurations, and recent changes to identify the root cause. The examination can include analyzing configuration files, recent software updates, hardware status, and network traffic logs to pinpoint any discrepancies or irregularities that could have contributed to the anomaly.

For example, the AI-based engine 406 can parse configuration files to check for misconfigurations or changes that can affect network performance. The AI-based engine 406 can alternatively or additionally review recent software updates and/or perform hardware status checks. By detecting unusual patterns or behaviors early, the AI-based engine 406 helps prevent potential service disruptions. Additionally, the anomaly detection model 408 can continuously learn from new data inputs and feedback loops to refine its anomaly detection algorithms, improving its accuracy over time. Further examples of anomaly detection model 408 are discussed with reference to FIG. 5. Further methods of AI and machine learning (ML) are discussed with reference to FIG. 7.

Additionally, the forecasting and trend detection model 410 within the AI-based engine 406 can include one or more AI models that use network-related metrics, such as an average failure rate and average response time, and the output of the anomaly detection model 408 to predict future network conditions and identify long-term trends. For example, a forecasting model can forecast potential risks, network load increases, and other factors that could impact network performance. Techniques like ARIMA can be used to predict future values based on past observations, considering trends, seasonality, and irregularities in the data. In some implementations, the forecasting model can assign exponentially decreasing weights to older observations, giving more weight to recent data. The forecasting model can generate forecasts for various network parameters such as traffic load, bandwidth utilization, server capacities, and/or user demand. These forecasts extend into the future based on the historical patterns observed in the data. The model can generate short-term, medium-term, and long-term forecasts, each tailored to different operational needs. In some implementations, the forecast model assesses potential risks and scenarios that could impact network performance. For example, the forecast model predicts network load increases during peak usage hours, identifies capacity constraints that can lead to service degradation, and/or anticipates spikes in demand for specific services.

In another example, a trend detection model can be used to identify and analyze long-term patterns and shifts in network behavior. In some implementations, the trend detection model separates a time series into its components: trend, seasonality, and noise. By isolating the trend component, the trend detection model can discern underlying long-term patterns in network metrics, such as increasing bandwidth usage over months or yearly fluctuations in data traffic. In some implementations, the trend detection model uses regression analysis and fits a curve to historical data points, capturing the overall direction and magnitude of changes in network performance metrics. Regression analysis involves fitting a mathematical model to the data, which can be linear or nonlinear, depending on the nature of the trend. The fitted curve can provide a visual representation of the trend and help quantify relationships between variables such as user demand and/or network capacity. Additionally or alternatively, the trend detection model identifies abrupt shifts or structural breaks in time series data, indicating significant changes in network behavior. Algorithms such as Bayesian change point analysis or CUSUM (Cumulative Sum) can be used to test periods where network performance trends deviate from historical norms. Bayesian change point analysis uses probabilistic methods to detect changes in the underlying distribution of the data, while CUSUM is a sequential analysis technique that monitors the cumulative sum of deviations from a target value. Further, the trend detection model can group similar data points into clusters based on shared characteristics to identify clusters representing stable periods versus those indicating changes or anomalies. Clustering algorithms like k-means or hierarchical clustering can be used to detect distinct patterns and trends in network behavior. Methods of implementing clustering algorithms are discussed in further detail with reference to the anomaly detection model 408. Further examples of forecasting and trend detection model 410 are discussed with reference to FIG. 5.

The recommendation engine 412 can generate feedback 414a-n (e.g., corrective actions) based on the analysis performed by the anomaly detection model 408 or initiate corrective actions automatically. The recommendation engine 412 can use the outputs of the anomaly detection model 408 and/or the forecasting and trend detection model 410 to generate the feedback 414a-n. Feedback 414a-n can include actions such as adjusting resource allocations and/or identifying the emerging issues. For instance, if the anomaly detection model identifies increased traffic on specific network elements, the recommendation engine 412 can suggest reallocating bandwidth or processing power to mitigate potential congestion. Actions can include, for example, dynamically adjusting the bandwidth allocation policies, redistributing processing loads across multiple servers, and/or provisioning additional resources to handle the increased traffic. By transmitting this feedback directly to the respective NPE clusters 402a-n, the AI-based engine 406 ensures that network management decisions are informed by accurate and timely information. The recommendations ensure that issues are addressed effectively, lowering the issues' impact on the network. For example, if the AI-based engine detects a delay in SMS message processing due to an overloaded server, the AI-based engine can automatically reallocate resources or reroute traffic to balance the load by shifting SMS processing tasks to underutilized servers, adjusting load-balancing algorithms, and/or temporarily increasing the processing capacity of the affected server.

In some implementations, the feedback 414a-n includes a faulty cluster (e.g., a set of faulty NPEs), or a subset of the network transaction data 404a-n, which is identified as contributing to or associated with anomalous behavior detected by the AI-based engine 406. The faulty cluster can include network elements, transactions, or configurations that are likely responsible for deviations from expected performance metrics or operational norms (e.g., the root cause of the anomaly). In some implementations, the actions within the feedback 414a-n are automatically executed. The automated execution can include predefined scripts or workflows that are triggered by specific anomalies, which can additionally ensure consistent and reliable responses to common issues.

Additionally, in some implementations, the AI-based engine 406 can trigger early warning alarms (e.g., alerts 416) for particular anomalies satisfying a particular threshold or criteria, providing users with diagnostic information to preemptively address issues. Alerts 416 notify the providers about the detected problems and can provide preliminary diagnostic information. Timely alerts 416 facilitate quick intervention, helping maintain the network's reliability and service quality. Alerts 416 reduces the mean time to repair and reduces the impact on end users, ensuring a more stable and reliable network experience.

The thresholds can be defined using standard deviations from the mean or percentiles of observed values. An anomaly exceeding the thresholds can indicate a deviation from normal network behavior that triggers an alert 416. In some implementations, one or more of the AI models can be used to define thresholds dynamically by continuously learning from new data to adjust thresholds based on evolving network conditions and emerging patterns of anomalies. In some implementations, network operators can establish rulesets based on domain knowledge and operational insights. For example, specific response time thresholds for network APIs or maximum error rates for data transactions can be predefined in the ruleset to trigger alerts when exceeded.

Alerts 416 can be triggered when anomalies surpass predefined severity levels. The severity can be assessed based on the impact on network performance, potential for service degradation, or deviation from expected operational norms. The predetermined criteria can include the duration and persistence of an anomaly over a specified timeframe. For instance, an anomaly persisting beyond a certain threshold duration can escalate the severity of the alert triggered. Alerts can consider contextual factors such as time of occurrence (e.g., peak vs. off-peak hours), user activity patterns, or recent network changes. Contextual awareness improves the usefulness of alerts 416 by contextualizing anomalies within the broader operational environment.

In some embodiments, once an alert is generated by the anomaly detection model 410, for example, indicating that a particular API is experiencing delays in NPE cluster 402b, the AI-based engine 406 can determine whether the detected delay in the particular API is isolated to NPE cluster 402b or if the detected delay is occurring across multiple clusters using the transaction data 404a-c. Depending on the output, the recommendation engine 412 can generate appropriate recommendations for the operations team. For example, if the issue is confined to NPE cluster 402b, the recommendation engine 412 can suggest taking NPE cluster 402b out of rotation with a lower severity alert. However, if the issue is detected across multiple clusters, the recommendation engine 412 can generate a high-severity alert, indicating that immediate operations support is required to address the widespread API delays. This approach allows the operations team to receive actionable recommendations based on the scope and severity of the detected anomalies.

FIG. 5 is a flowchart representation of a process or a method 500 for predicting network element issues in wireless networks in accordance with one or more implementations of the present technology. In some implementations, the method 500 is performed by components of example wireless devices 104 illustrated and described in more detail with reference to FIG. 1. Likewise, implementations can include different and/or additional acts or can perform the acts in different orders.

In operation 502, the system operates one or more NPEs (e.g., NPEs 304 in FIG. 3). The network provisioning engine is configured to receive a request associated with a user profile. The request can include one or more user service attributes (e.g., CFSs) based on a service (e.g., a product related to a service such as rate plans 302a-n in FIG. 3) within the wireless communication network. In some implementations, the one or more network provisioning engines translate, via a network provisioning catalog, the one or more user service attributes to (i) the one or more network nodes in the wireless communication network, and (ii) the set of network service attributes for each network node. For example, the one or more network provisioning engines can send, to the network provisioning catalog (e.g., network provisioning catalog 308 in FIG. 3), the one or more user service attributes. The network provisioning engine can receive, from the network provisioning catalog, information about one or more network nodes in the wireless communication network. The information can include a set of network service attributes for each network node (e.g., network elements 310a-n in FIG. 3) associated with the one or more user service attributes.

In some implementations, the set of network service attributes includes a first set indicating required network service attributes and a second set indicating network service attributes that are in use. The first set of the network service attributes can define a set of expected network service attributes of the wireless communication network, and can include attributes of the network under normal operating conditions. The second set of the network service attributes can define a set of observed network service attributes of the wireless communication network, and can be derived from measurements and/or observations of the network's operational state. The network nodes and the first set of network service attributes can be related to the one or more user service attributes. The network provisioning engine can query the network nodes for the second set of network service attributes corresponding to the first set of network service attributes, and receive, from the network nodes, the second set of network service attributes.

In operation 504, the system obtains, via an AI-based engine (e.g., AI-based engine 406 in FIG. 4), network transaction data (e.g., transaction data 404a-n in FIG. 4) from the network provisioning engine. The network transaction data can be associated with at least the request associated with the user profile and the set of network service attributes. The AI-based engine can include one or more AI models trained (e.g., anomaly detection model 408 in FIG. 4, forecasting and trend detection model 410 in FIG. 4) on historical network transaction data to recognize patterns preceding a service disruption. In some implementations, the network transaction data includes provisioning logs, response times, and/or error rates of the network provisioning engine.

In operation 506, the system identifies, via the AI-based engine, anomalous data based on the network transaction data, where the anomalous data can be associated with the set of patterns and provide an indicator of a service disruption based on the network transaction data. The system supplies, to one or more AI models, the network transaction data. The system receives, from the one or more AI models, anomalous data (e.g., feedback 414a-n in FIG. 4) within the network transaction data associated with the indicator of the service disruption. The anomalous data can be related to the second set of network service attributes failing to align with the first set of network service attributes.

The one or more AI models can include an anomaly detection model, a forecasting model, and/or a trend detection model. The anomaly detection model can identify outliers within the network transaction data. The anomaly detection model can use Gaussian distribution modeling to detect the anomalous data based on deviations from expected statistical distributions of the network transaction data, as described in further detail with reference to FIG. 4 and FIG. 6. In some implementations, the anomaly detection model uses ARIMA to evaluate temporal patterns and identify the anomalous data over time, as described in further detail with reference to FIG. 4. Additionally, the anomaly detection model can use k-means clustering and/or Density-Based Spatial Clustering of Applications with Noise (DBSCAN) to group similar network transaction data based on the set of patterns, and flag outliers as potential anomalous data, as described in further detail with reference to FIG. 4 and FIG. 6.

The forecasting model can predict future trends associated with the service disruption within the network based on the network transaction data and the identified outliers. The trend detection model can identify patterns that indicate expected network transaction data using the predicted future trends, the outliers, and/or the network transaction data. For example, the trend detection model can separate a time series into one or more of: trend, seasonality, and/or noise, and fit a curve to the network transaction data. In some implementations, using the anomalous data, the system correlates the anomalous data with the user profile, the request, the one or more user service attributes, the network nodes, the first set of network service attributes, and/or the second set of network service attributes.

In operation 508, the system can determine, via the AI-based engine, based on the anomalous data, a set of faulty NPEs of the one or more NPEs associated with the anomalous data by, for example, correlating the anomalous data with the user profile, the request, the one or more user service attributes, the one or more network nodes, and/or the set of network service attributes. The set of faulty NPEs includes a subset of the network transaction data correlated with the anomalous data. For example, the set of faulty NPEs can include a group of NPEs or network nodes that are not performing as expected or are contributing to network issues. The system can correlate the anomalous data with the user profile, the request, the one or more user service attributes, the one or more network nodes, and/or the set of network service attributes.

The system can generate a set of actions configured to modify the network transaction data to align the first set of network service attributes with the second set of network service attributes. In some implementations, the system can automatically execute the set of actions via the one or more network provisioning engines. In some implementations, the system triggers one or more alarms via the AI-based engine in response to the indicator of the service disruption satisfying a set of predetermined criteria.

### AI System

FIG. 6 is a block diagram illustrating an example artificial intelligence (AI) system 600, in accordance with one or more implementations of this disclosure. The AI system 600 is implemented using components of the example computer system 700 illustrated and described in more detail with reference to FIG. 7. For example, the AI system 600 can be implemented using the processor 702 and instructions 708 programmed in the memory 706 illustrated and described in more detail with reference to FIG. 7. Likewise, implementations of the AI system 600 can include different and/or additional components or be connected in different ways.

As shown, the AI system 600 can include a set of layers, which conceptually organize elements within an example network topology for the AI system's architecture to implement a particular AI model 630. Generally, an AI model 630 is a computer-executable program implemented by the AI system 600 that analyzes data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking, such as the resources described in relation to FIG. 7. The hardware platform 610 can process amounts of data using one or more servers. The servers can perform backend operations such as matrix calculations, parallel calculations, machine learning (ML) training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but can be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources, (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include Intel Math Kernel Library, Nvidia cuDNN, Eigen, and Open BLAS.

The structure layer 604 can include a machine learning (ML) framework 614 and an algorithm 616. The ML framework 614 can be thought of as an interface, library, or tool that allows users to build and deploy the AI model 630. The ML framework 614 can include an open-source library, an application programming interface (API), a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630.

Examples of ML frameworks 614 or libraries that can be used in the AI system 600 include TensorFlow, PyTorch, Scikit-Learn, Keras, and Cafffe. Random Forest is a machine learning algorithm that can be used within the ML frameworks 614. LightGBM is a gradient boosting framework/algorithm (an ML technique) that can be used. Other techniques/algorithms that can be used are XGBoost, CatBoost, etc. Amazon Web Services is a cloud service provider that offers various machine learning services and tools (e.g., Sage Maker) that can be used for platform building, training, and deploying ML models.

In some implementations, the ML framework 614 performs deep learning (also known as deep structured learning or hierarchical learning) directly on the input data to learn data representations, as opposed to using task-specific algorithms. In deep learning, no explicit feature extraction is performed; the features of feature vector are implicitly extracted by the AI system 600. For example, the ML framework 614 can use a cascade of multiple layers of nonlinear processing units for implicit feature extraction and transformation. Each successive layer uses the output from the previous layer as input. The AI model 630 can thus learn in supervised (e.g., classification) and/or unsupervised (e.g., pattern analysis) modes. The AI model 630 can learn multiple levels of representations that correspond to different levels of abstraction, wherein the different levels form a hierarchy of concepts. In this manner, AI model 630 can be configured to differentiate features of interest from background features.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data can be labeled by an external user or operator. For instance, a user can collect a set of training data, such as by capturing application and/or service usage patterns, metadata, historical communication sessions, and the like (detailed further in FIG. 4). The user can label the training data based on one or more classes and trains the AI model 630 by inputting the training data to the algorithm 616. The algorithm determines how to label the new data based on the labeled training data. The user can facilitate collection, labeling, and/or input via the ML framework 614. In some instances, the user can convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., features of historical transaction data of FIG. 4) relate to the categories (e.g., services and applications). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Another way unsupervised learning is used to train the algorithm 616 to find an underlying structure of a set of data is to group the data according to similarities and represent that set of data in a compressed format. The network 100 disclosed herein can use unsupervised learning to identify patterns in data received.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 can be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 can be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that can be used by the algorithm 616 include factor analysis, item response theory, latent profile analysis, and latent class analysis.

In some implementations, the AI system 600 trains the algorithm 616 of AI model 630, based on the training data, to correlate the feature vector to expected outputs in the training data. As part of the training of the AI model 630, the AI system 600 forms a training set of features and training labels by identifying a positive training set of features that have been determined to have a desired property in question, and, in some implementations, forms a negative training set of features that lack the property in question. The AI system 600 applies ML framework 614 to train the AI model 630, that when applied to the feature vector, outputs indications of whether the feature vector has an associated desired property or properties, such as a probability that the feature vector has a particular Boolean property, or an estimated value of a scalar property. The AI system 600 can further apply dimensionality reduction (e.g., via linear discriminant analysis (LDA), PCA, or the like) to reduce the amount of data in the feature vector to a smaller, more representative set of data.

The model layer 606 implements the AI model 630 using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers can include an input layer of nodes that receive input data, an output layer of nodes that produce output data. The model structure 620 can include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 630 performance during training. For instance, the loss function engine 624 can measure the difference between a predicted output of the AI model 630 and the actual output of the AI model 630 and is used to guide optimization of the AI model 630 during training to minimize the loss function. The loss function can be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used can be determined based on the type of model structure 620 and the size of data and the computing resources available in the data layer 602.

The regularization engine 628 executes regularization operations. Regularization is a technique that prevents over- and under-fitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constraint the resulting AI model 630 and improves its ability for generalized application. Examples of regularization techniques include lasso (L1) regularization, ridge (L2) regularization, and elastic (L1 and L2 regularization).

In some implementations, the AI system 600 can include a feature extraction module implemented using components of the example computer system 700 illustrated and described in more detail with reference to FIG. 7. In some implementations, the feature extraction module extracts a feature vector from input data. The feature vector includes n features (e.g., feature a, feature b, . . . , feature n). The feature extraction module reduces the redundancy in the input data, e.g., repetitive data values, to transform the input data into the reduced set of features such as feature vector. The feature vector contains the relevant information from the input data, such that events or data value thresholds of interest can be identified by the AI model 630 by using this reduced representation. In some example implementations, the following dimensionality reduction techniques are used by the feature extraction module: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A system for predicting service disruptions in a wireless communication network, the system comprising:
one or more network provisioning engines, wherein each network provisioning engine is configured to:
receive a request associated with a user profile, wherein the request comprises one or more user service attributes based on a service within the wireless communication network, and
receive information about one or more network nodes in the wireless communication network, wherein the information comprises a set of network service attributes for each network node associated with the one or more user service attributes; and
an engine including one or more machine learning models trained on historical network transaction data to recognize a set of patterns within the historical network transaction data preceding a service disruption, wherein the engine is configured to:
obtain network transaction data from the one or more network provisioning engines,
wherein the network transaction data is associated with at least the request associated with the user profile and the set of network service attributes, and
wherein the network transaction data includes one or more of: provisioning logs, response times, or error rates of the one or more network provisioning engines;
identify anomalous data based on the network transaction data, wherein the anomalous data is associated with the set of patterns, and
determine, based on the anomalous data, a set of faulty network provisioning engines of the one or more network provisioning engines associated with the anomalous data,
wherein the set of faulty network provisioning engines is associated with at least the set of network service attributes correlated with the anomalous data.

2. The system of claim 1, wherein determining the set of faulty network provisioning engines further causes the system to:
correlate the anomalous data with one or more of: the user profile, the request, the one or more user service attributes, the one or more network nodes, or the set of network service attributes.

3. The system of claim 1, wherein the set of network service attributes comprises a first set indicating required network service attributes and a second set indicating network service attributes that are in use.

4. The system of claim 3, wherein the system is further caused to:
generate a set of actions configured to modify the network transaction data to align the first set of the network service attributes with the second set of the network service attributes; and
automatically execute the set of actions via the one or more network provisioning engines.

5. The system of claim 3, wherein the anomalous data is related to the second set of the network service attributes failing to align with the first set of the network service attributes.

6. The system of claim 1, wherein the engine is further configured to generate a set of feedback indicating the set of faulty network provisioning engines.

7. The system of claim 1, wherein the system is further caused to:
trigger one or more alarms via the engine in response to the anomalous data satisfying a set of predetermined criteria.

8. A device for predicting service disruptions in a wireless communication network, comprising:
at least one hardware processor; and
at least one non-transitory memory storing instructions, which, when executed by the at least one hardware processor, cause the device to:
communicate with one or more network provisioning engines, wherein each network provisioning engine is configured to:
receive a request associated with a user profile, wherein the request comprises one or more user service attributes based on a service within the wireless communication network, and
receive information about one or more network nodes in the wireless communication network, wherein the information comprises a set of network service attributes for each network node associated with the one or more user service attributes,
obtain network transaction data from the one or more network provisioning engines, wherein the network transaction data is associated with at least the request associated with the user profile and the set of network service attributes;
identify, based on the network transaction data, anomalous data associated with a set of patterns, wherein the anomalous data is identified using one or more machine learning models trained on historical network transaction data to recognize the set of patterns within the historical network transaction data preceding a service disruption; and
determine, based on the anomalous data, a set of faulty network provisioning engines of the one or more network provisioning engines associated with the anomalous data,
wherein the set of faulty network provisioning engines is associated with at least the set of network service attributes correlated with the anomalous data.

9. The device of claim 8, wherein the one or more network provisioning engines is further configured to:
translate, via a network provisioning catalog, the one or more user service attributes to (i) the one or more network nodes in the wireless communication network, and (ii) the set of network service attributes for each network node.

10. The device of claim 8, wherein the one or more network provisioning engines is further configured to:
send, to a network provisioning catalog, the one or more user service attributes,
query the one or more network nodes for the set of network service attributes for each network node, and
receive, from the one or more network nodes, the set of network service attributes for each network node.

11. The device of claim 8, wherein the one or more user service attributes is based on a product related to the service within the wireless communication network.

12. The device of claim 8, wherein the one or more machine learning models include one or more of: an anomaly detection model, a forecasting model, or a trend detection model,
wherein the anomaly detection model is configured to identify a set of outliers within the network transaction data,
wherein the forecasting model is configured to predict one or more future trends associated with the service disruption within the wireless communication network based on the network transaction data and the set of outliers, and
wherein the trend detection model is configured to identify the set of patterns that indicate expected network transaction data using the one or more future trends, the set of outliers, and the historical network transaction data.

13. The device of claim 8,
wherein the set of network service attributes comprises a first set indicating required network service attributes and a second set indicating network service attributes that are in use,
wherein the first set of the network service attributes defines a set of expected network service attributes of the wireless communication network, and
wherein the second set of the network service attributes defines a set of observed network service attributes of the wireless communication network.

14. The device of claim 8, wherein the anomalous data is identified by:
supplying, to one or more AI models, the set of network service attributes, and
receiving, from the one or more AI models, the anomalous data within the set of network service attributes.

15. A method for predicting service disruptions in a wireless communication network, the method comprising:
operating one or more network provisioning engines, wherein each network provisioning engine is configured to:
receive a request associated with a user profile, wherein the request comprises one or more user service attributes based on a service within the wireless communication network, and
receive information about one or more network nodes in the wireless communication network, wherein the information comprises a set of network service attributes for each network node associated with the one or more user service attributes,
obtaining, via an engine, network transaction data from the one or more network provisioning engines,
wherein the network transaction data is associated with at least the request associated with the user profile and the set of network service attributes, and
wherein the engine includes one or more machine learning models trained on historical network transaction data to recognize a set of patterns within the historical network transaction data preceding a service disruption;
identifying, via the engine, anomalous data based on the network transaction data, wherein the anomalous data is associated with the set of patterns; and
determining, via the engine based on the anomalous data, a set of faulty network provisioning engines of the one or more network provisioning engines associated with the anomalous data,
wherein the set of faulty network provisioning engines is associated with at least the set of network service attributes correlated with the anomalous data.

16. The method of claim 15, further comprising:
correlating the anomalous data with one or more of: the user profile, the request, the one or more user service attributes, the one or more network nodes, or the set of network service attributes.

17. The method of claim 15,
wherein the one or more machine learning models includes an anomaly detection model, and
wherein the anomaly detection model is configured to use Gaussian distribution modeling to detect the anomalous data based on deviations from expected statistical distributions of the network transaction data.

18. The method of claim 15, further comprising:
wherein the one or more machine learning models includes an anomaly detection model, and
wherein the anomaly detection model is configured to use Autoregressive Integrated Moving Average (ARIMA) to evaluate temporal patterns and identify the anomalous data over time.

19. The method of claim 15, further comprising:
wherein the one or more machine learning models includes an anomaly detection model, and
wherein the anomaly detection model is configured to use one or more of: k-means clustering or Density-Based Spatial Clustering of Applications with Noise (DBSCAN) to:
group similar network transaction data based on the set of patterns, and
flag outliers as potential anomalous data.

20. The method of claim 15, further comprising:
wherein the one or more machine learning models includes a trend detection model,
wherein the trend detection model separates a time series into one or more of: trend, seasonality, and noise, and
wherein the trend detection model is configured to fit a curve to the network transaction data.
